(19) United States
(12) Patent Application Publication
(10) Pub. No.: US 2024/0162564 A1
(43) Pub. Date: May 16, 2024

(54) COATED NON-WOVEN LITHIUM ION BATTERY SEPARATORS WITH HIGH TEMPERATURE RESISTANCE

(71) Applicant: AHLSTROM-MUNKSJÖ OYJ, Helsinki (FI)

(72) Inventors: Raoudha Haddad, Pont-Evêque (FR); Bertrand Rupin, Grenoble (FR)

(21) Appl. No.: 18/550,695

(22) PCT Filed: Mar. 15, 2022
(86) PCT No.: PCT/FI2022/050167

§ 371 Date: Sep. 15, 2023

Related U.S. Application Data
(60) Provisional application No. 63/161,280, filed on Mar. 15, 2021.

(51) Int. Cl. H01M 50/429; H01M 10/0525; H01M 50/403; H01M 50/423; H01M 50/44; H01M 50/449; H01M 50/491

(52) U.S. Cl. CPC H01M 50/4295; H01M 10/0525; H01M 50/403; H01M 50/423; H01M 50/44; H01M 50/449; H01M 50/491

(57) ABSTRACT

It is described herein a battery separator comprising a non-woven substrate and a binder. The non-woven substrate may comprise highly refined cellulosic fibers and synthetic fibers. The battery separator may have a mean pore size in a range of between 0.4 and 3 μm. It is also described herein a lithium-ion battery comprising the battery separator, and a process for producing a battery separator.

### CROSS-REFERENCE TO RELATED APPLICATION

This application is based on and claims priority to International Application No. PCT/FI2022/050167 filed on Mar. 15, 2022, and U.S. Patent Application No. 63/161,280 filed on Mar. 15, 2021, in the United States Patent and Trademark Office, and all the benefits accruing therefrom under 35 U.S.C. § 119, the contents of each of which are incorporated by reference herein in their entirety.

### BACKGROUND

In the field of battery technology, and specifically lithium-ion battery technology, battery separators are commonly used to separate the anode (negative) and cathode (positive) portions of the battery while enabling the exchange of lithium ions from one portion to the other. Lithium-ion batteries in particular are known to face several challenges related to battery separator performance. Specifically, lithium-ion batteries pose a high risk of explosion due to shrinkage of the battery separator and low resistance to elevated temperatures. Lithium-ion batteries also face challenges related to decreased performance due to low ionic conductivity of battery separators.

Many solutions have been proposed for improving the safety and performance characteristics of battery separators. For example, International Patent Publication No. WO 2018/085828 discloses a battery separator comprising a microporous polymeric film; and an optional coating layer on at least one side of the microporous polymeric film, wherein at least one of the microporous polymeric film and the optional coating comprises an additive. Specifically, the microporous polymeric film or membrane is a microporous polyolefin membrane such as a dry stretch process membrane such as a monolayer dry-process film, a bilayer dry-process film, or a multilayer dry-process film. The coating may be a ceramic coating. The additive is selected from the group consisting of a lubricating agent, a plasticizing agent, a nucleating agent, a shrinkage reducing agent, a surfactant, an SEI improving agent, a cathode protection agent, a flame retardant additive, LiPF₆ salt stabilizer, an overcharge protector, an aluminum corrosion inhibitor, a lithium deposition agent or improver, or a solvation enhancer, an aluminum corrosion inhibitor, a wetting agent, and a viscosity improver.

Another solution is disclosed in United States Patent Application Publication No. 2015/0017512 A1 which discloses producing a separator comprising the steps of: providing a sheetlike porous substrate, a solvent, ceramic particles and an adhesion promoter; preparing a slip by mixing the solvent, the adhesion promoter and the ceramic particles; coating the substrate with the slip and thermally drying the coated substrate to obtain the separator. The porous substrate used is preferably a fibrous non-woven web. It is preferable to use a fibrous nonwoven web composed of organic fibres, wherein the organic fibres are selected from polyacrylonitrile, polyester, polyimide, polyamide, polytetrafluoroethylene, polyethylene terephthalate or polyolefin.

United States Patent Application Publication No. 2014/0127546 A1 discloses another solution. The solution disclosed therein involves a separator which has a porous coating which is not electrically conductive and is composed of oxide particles which are adhesively bonded to one another and to the substrate by means of an inorganic adhesive and comprise at least one oxide selected from among Al₂O₃ and SiO₂ on a substrate and in the interstices of the substrate which has fibres composed of a material which is not electrically conductive.

Still another solution is disclosed in United States Patent Application Publication No. 2012/0308871 A1. The solution disclosed therein involves a ceramic composite material, comprising a planar carrier substrate and a porous coating that is applied onto the carrier substrate and contains ceramic particles.

United States Patent Application Publication No. 2015/0037654 A discloses still another solution. The solution disclosed therein relates to a perforated polymer film with porosity P from 30% to 50% and with an arrangement of perforations which is characterized by the perforation shape, the ratio of the semiaxes of the perforations, the orientation of the perforations, and the regular arrangement of the perforations. The material of the polymer film according to the invention can be one selected from polyethylene (PE), polypropylene (PP), polyethylene glycol terephthalate (PET), polyethylene glycol naphthenate (PEN), polylactic acid (PLA), polyacrylonitrile (PAN), polyamides (PA), aromatic polyamides (Ar), polymethyl methacrylate (PMMA), polyimide (PI), polyester copolymers, polyolefins, fluorinated polymers, polystyrene, polycarbonate, acrylonitrile-butadiene-styrene, cellulose ester, copolymers of the said polymers, and mixtures of the said polymers and/or copolymers.

Another solution is disclosed in United States Patent Application Publication No. 2014/0134496 A1. The solution disclosed therein relates to an insulating (nonconductive) microporous polymeric battery separator comprised of a single layer of enmeshed microfibers and nanofibers. The microfiber constituent may be of any suitable polymer that provides the necessary chemical and heat resistance. The nanofibers may thus be of any like polymer constituency and/or combination in order to withstand the same types of chemical and high temperature exposures as for the microfibers.

To date, the solutions proposed in the prior art have been known to suffer from several shortcomings. Specifically, these solutions are known to provide insufficient porosity and flexibility making the known battery separators difficult to handle during the battery manufacturing process. Additionally, the known battery separators often suffer from issues related to poor adhesion of coated particles to the battery separator substrate. Finally, the known battery separators suffer from poor affinity with organic solvents.

The need exists, therefore, for an improved battery separator which has sufficient porosity and flexibility and high solvent wettability while allowing for high temperature resistance and improved control of dendrite formation.

### SUMMARY

Described herein is a battery separator comprising a non-woven substrate and a binder. The non-woven substrate may comprise highly refined cellulosic fibers and synthetic fibers. The battery separator may have a mean pore size in a range of between 0.4 and 3 μm.

In some embodiments, the highly refined cellulosic fibers may be selected from the group consisting of hardwood fibers, softwood fibers, regenerated cellulose fibers such as Lyocell fibers, and combinations thereof. One such example of highly refined cellulosic fibers are bleached softwood fibers.

In certain embodiments, the synthetic fibers may be selected from the group consisting of polyester fibers, polyolefin fibers, polyaramid fibers, and combinations thereof. The synthetic fibers may have a synthetic fiber diameter of less than 10 μm. The synthetic fibers may have a synthetic fiber length of no greater than 12 mm. The synthetic fibers may be present in the non-woven substrate at a level of at least 20 wt. % based on total weight of the fibers in the non-woven substrate.

Certain embodiments of the battery separator may further comprise micro fibrillated cellulosic fibers. When present, the micro fibrillated cellulosic fibers may be present in the non-woven substrate in a range of between 10 and 30 wt. % based on total weight of the fibers in the non-woven substrate.

Some embodiments of the battery separator may further comprise aramid fibers. One such example of aramid fibers are para-aramid fibers.

In certain embodiments, the binder may be a polymer binder. Such polymer binder may have a melting point greater than 80° C. The polymer binder may comprise a polymer selected from the group consisting of styrene-butadiene polymers, polyolefins, polyvinylidene fluoride (PVDF), polytetrafluoroethylene (PTFE), and acrylics or combinations thereof.

In other embodiments, the polymer binder may comprise a cellulose, cellulose-based (i.e., cellulose-containing) or cellulose-derived polymers or combinations thereof. Examples of such binders include binders comprising cellulose ethers such as methyl cellulose or carboxymethyl cellulose, binders comprising cellulose esters such as cellulose acetates, binders comprising cellulose polymers such as cellulose nanocrystals (CNCs), nanofibrillated cellulose (NFCs), microfibrilliated cellulose (MFCs), lignocellulose, regenerated cellulose or combinations thereof. It is believed that binders comprising cellulose, cellulose-based or cellulose-derived polymers may have greater affinity to the cellulose fibers in nonwoven substrate.

In some embodiments, the non-woven substrate may be coated with the binder. In other embodiments, the binder may be a binder layer formed on at least one surface of the non-woven substrate. In certain such embodiments, the binder of the binder layer may penetrate a depth of the non-woven substrate in the z-direction.

The battery separator may have a first porosity of less than 2 L/min. The battery separator may also have an LP40 electrolyte contact angle measurement of less than 10° after 1 minute.

Also described herein is a lithium-ion battery comprising a battery separator of the type disclosed herein.

Further described herein is a process for producing a battery separator. The process may comprise the steps of: A. providing an amount of cellulosic fibers; B. subjecting the cellulosic fibers to a refining step to obtain highly refined cellulosic fibers having a refining degree of at least 60° when measured using a Schopper-Reigler (SR) freeness tester; C. adding an amount of synthetic fibers to the highly refined cellulosic fibers to obtain a first fiber mixture; D. adding an amount of a first solvent to the first fiber mixture to obtain a first fibrous slurry, wherein the first solvent may comprise water; E. transferring the first fibrous slurry to a headbox; F. depositing the first fibrous slurry to a forming wire or forming fabric; G. applying a vacuum condition to the first fibrous slurry to remove at least a portion of the first solvent and form a non-woven substrate; and H. applying a binder to at least a first surface of the non-woven substrate to obtain the battery separator.

In some embodiments, step A of the process may further comprise providing an amount of aramid fibers, and step B of the process may further comprise subjecting the aramid fibers to the refining step. In certain embodiments, the process may further comprise step I. subjecting the battery separator to calendaring.

Also described herein is the use of a structure of the type disclosed herein, i.e., a battery separator comprising a sheet-like porous structure comprising a non-woven substrate, comprising highly refined cellulosic fibers and synthetic fibers, and a binder, wherein the sheet-like porous structure has a mean pore size in a range between 0.4 and 3 μm, particularly in lithium-ion batteries.

### DETAILED DESCRIPTION

Disclosed herein is a battery separator. Also disclosed herein is a lithium-ion battery comprising a battery separator. Further disclosed herein is a process for producing a battery separator.

The battery separator may comprise a non-woven substrate and a binder. As used herein and in the claims, the term “non-woven refers to a sheet, web, or batt of fibers—including paper—which are interlocked, entangled, and/or bonded to one another thermally, chemically and/or mechanically. In general, the non-woven substrate may comprise highly refined cellulosic fibers and synthetic fibers.

As used herein and in the claims, highly refined cellulosic fibers refer to fibers composed of or derived from cellulose having at least 60 weight percent (wt. %) fines based on total weight of the cellulosic fibers with at least 35 wt. %, preferably 40 wt. % secondary fines based on total weight the fines. As used herein and in the claims, fines refers to cellulosic material after refining which is small enough to pass through a forming wire or forming fabric. As used herein and in the claims, secondary fines refers to ribbon-like structures produced during refining which demonstrate a tendency to fill spaces between fibers. Preferred, non-limiting examples of highly refined cellulosic fibers include highly refined hardwood fibers, highly refined softwood fibers, regenerated cellulose fibers such as Lyocell fibers, and combinations thereof. A preferred highly refined cellulosic fiber is bleached softwood fibers, for example northern bleached softwood kraft (NBSK) fibers and/or southern bleached softwood kraft (SBSK) fibers.

As used herein and in the claims, synthetic fibers refer to fibers made from fiber-forming substances including polymers synthesized from chemical compounds. Preferred, non-limiting examples of synthetic fibers include polyester fibers, polyolefin fibers, polyaramid fibers, and combinations thereof.

The synthetic fibers will have a synthetic fiber diameter. Preferred synthetic fiber diameters may be less than 10 micrometers (μm), less than 7.5 μm, or less than 5.0 μm. The synthetic fibers will also have a synthetic fiber length. Preferred synthetic fiber lengths may be no greater than 12 millimeters (mm), no greater than 10 mm, or no greater than 7.5 mm.

The synthetic fibers will be present in the non-woven substrate in an amount of synthetic fibers. The amount of synthetic fibers may be expressed as a weight percentage (i.e., wt. %) based on the total weight of the non-woven substrate. Preferably, the synthetic fibers may be present in the non-woven substrate at a level of at least 20 wt. % based on total weight of the fibers in the non-woven substrate, at least 25 wt. % based on total weight of the fibers in the non-woven substrate, or at least 30 wt. % based on total weight of the fibers in the non-woven substrate.

In some embodiments, the non-woven substrate may further comprise micro fibrillated cellulosic fibers. As used herein and in the claims, micro fibrillated cellulosic fibers refer to cellulose in which the outer layer of the fibers has been stripped away by mechanical shearing, exposing the fibril bundles. The micro fibrillated cellulosic fibers may have an average fiber length of less than 0.8 mm, preferably less than 0.75 mm, and an average fiber width of less than 30 μm, preferably less than 27.5 μm.

When used, the micro fibrillated cellulosic fibers may be present in the non-woven substrate in an amount of micro fibrillated cellulosic fibers. The amount of micro fibrillated fibers may be expressed as a weight percentage based on the total weight of fibers in the non-woven substrate. Preferably, when used, the micro fibrillated cellulosic fibers may be present in the non-woven substrate at a level of greater than 10 wt. % based on total weight of the fibers in the non-woven substrate, greater than 15 wt. % based on total weight of the fibers in the non-woven substrate, greater than 20 wt. % based on total weight of the fibers in the non-woven substrate, greater than 25 wt. % based on total weight of the fibers in the non-woven substrate, or greater than 30 wt. % based on total weight of the fibers in the non-woven substrate.

In some embodiments, the non-woven substrate may further comprise aramid fibers. The aramid fibers may be present with or within the presence of micro fibrillated cellulosic fibers as described herein. As used herein and in the claims, aramid fibers refer to synthetic fibers of the aromatic polyamide type in which at least 85% of the amide linkages are attached directly to two aromatic rings. Aramid fibers are known for their heat and flame resistance. Preferred, non-limiting examples of aramid fibers include para-aramid fibers.

As used herein and in the claims a binder refers to a material which holds or draws together the fibers. The binder will have a melting point with the preferred binder melting point being greater than 80° C. with greater than 90° C. being more preferred and greater than 100° C. being most preferred.

Preferably, the binder may be a polymer binder. The polymer binder may comprise a polymer selected from the group consisting of styrene-butadiene polymers, polyolefins, polyvinylidene fluoride (PVDF), polytetrafluoroethylene (PTFE), and acrylics or combinations thereof. In other embodiments, the polymer binder may comprise a cellulose, cellulose-based or cellulose-derived polymers or combinations thereof. The polymer of the polymer binder will have a melting point with the preferred melting point being greater than 80° C., greater than 90° C., or greater than 100° C.

In some embodiments, the non-woven substrate may be coated with the binder. By coated with the binder, it is meant that the non-woven substrate is impregnated with the binder. In other words, the binder is applied to the non-woven substrate in a manner such that there is no distinct interface between the non-woven substrate layer and the binder. Many methods may be used to coat the non-woven substrate with the binder. Non-limiting examples of such methods include size press coating, spray coating, rod coating, kiss coating, direct coating, and reverse roll coating.

In other embodiments, instead of a coating having no distinct interface between the non-woven substrate and the binder, the binder may be present as a binder layer formed on at least one surface of the non-woven substrate. By binder layer, it is meant that the binder is applied to the non-woven substrate in a manner such that there is a distinct interface between the non-woven substrate layer and the binder layer, even though a portion of the binder may penetrate the non-woven substrate layer's depth in the z-direction. The binder layer may be formed on one or both sides of the non-woven substrate during formation of the non-woven substrate using a wet-laid process.

Prior to applying the binder (either as a coating or as a separate layer), the non-woven substrate will have a thickness. Preferably the thickness will be in a range selected from the group consisting of between 30 μm and 100 μm, between 30 μm and 80 μm, between 30 μm and 60 μm, between 40 μm and 100 μm, between 40 μm and 80 μm, between 40 μm and 60 μm, between 50 μm and 100 μm, between 50 μm and 80 μm, and between 50 μm and 60 μm.

In some embodiments, the non-woven substrate may be calendared prior to, during, and/or after the process of applying the binder. Calendaring refers to a finishing process in which the non-woven substrate is passed through calendar rollers at elevated temperature and pressure to smoothen the substrate. After calendaring, the non-woven substrate (with or without binder) will have a thickness. Preferably the thickness after calendaring will be in a range selected from the group consisting of between 10 μm and 30 μm, between 10 μm and 25 μm, between 10 μm and 20 μm, between 15 μm and 30 μm, between 15 μm and 25 μm, and between 20 μm and 30 μm.

The completed battery separator will have a mean pore size. As used herein and in the claims, the mean pore size refers to the pore size measured according to ASTM F316-03 (2011)—Standard Test Methods for Pore Size Characteristics of membrane Filters by Bubbler Point and Mean Flow Pore Test using a Porometer 30 produced by Quantachrome Instruments of Boynton Beach, Florida, U.S.A. In preferred embodiments, the mean pore size of the battery separator may be in a range of between 0.4 and 3 μm. A mean pore size of the battery separator in a range of between 0.4 and 2.5 μm is more preferred with a mean pore size of the battery separator in a range of between 0.4 and 2.0 μm being most preferred.

The completed battery separator will have a mass per unit area. Preferably the mass per unit area, expressed in grammage (i.e., grams per square meter, gsm), will be in a range selected from the group consisting of between 10 gsm and 30 gsm, between 10 gsm and 25 gsm, between 10 gsm and 20 gsm, between 15 gsm and 30 gsm, between 15 gsm and 25 gsm, and between 20 gsm and 30 gsm.

Of the mass per unit area of the battery separator, a certain portion will comprise the binder. Preferably the mass per unit area of the binder, expressed in grammage, will be in a range selected from the group consisting of between 1 gsm and 8 gsm, between 1 gsm and 6 gsm, between 1 gsm and 4 gsm, between 2 gsm and 8 gsm, between 2 gsm and 6 gsm, and between 2 gsm and 4 gsm.

The completed battery separator will also have a first porosity which may be measured relative to a second porosity of a similar battery separator which does not comprise the binder. Porosity refers to Bendsten porosity, which is a measure of the air flow through the pores of a media (i.e.—an air permeability). The porosity of the battery separator is measured using a Bendtsen porosity tester, which calculates porosity by forcing air through the sheet and measuring the rate of flow, according to ISO Standard 5636-3. A similar battery separator which does not comprise the binder refers generally to a non-woven substrate comprising the same or similar components (types of fibers, amounts of different fibers, fiber lengths, fiber diameters) as those found in the battery separator. The first porosity of the battery separator is preferably 50% less than the second porosity of the similar battery separator, more preferably 60% less than the second porosity of the similar battery separator, and most preferably 70% less than the second porosity of the similar battery separator.

The first porosity, which is measured after applying the binder (with or without optional calendaring) may be in a measured range. For example, the first porosity may be in a range selected from the group consisting of between 0.03 liter per minute (L/min) and 2 L/min, between 0.03 L/min and 1.5 L/min, between 0.03 L/min and 1 L/min, between 0.05 L/min and 2 L/min, between 0.05 L/min and 1.5 L/min, and between 0.05 L/min and 1 L/min.

Similarly, the second porosity, which is measured before applying the binder (and before optional calendaring) may be in a measured range. For example, the second porosity may be in a range selected from the group consisting of between 0.3 L/min and 30 L/min, between 0.3 L/min and 20 L/min, between 0.3 L/min and 10 L/min, between 1 L/min and 30 L/min, between 1 L/min and 20 L/min, between 1 L/min and 10 L/min, between 5 L/min and 30 L/min, between 5 L/min and 20 L/min, and between 5 L/min and 10 L/min.

The completed battery separator will also have an LP40 electrolyte contact angle. The LP40 electrolyte contact angle refers to the angle formed between a droplet of LP40 electrolyte and the battery separator after 1 minute as measured according to SAE International test method J2983 (October 2019)—Recommended Practice for Determining Material Properties of Li-Battery Separator. Decreased contact angle is believed to improve wettability of the battery separator which improves the ionic conductivity through the separator as well as resulting in less dendric formation. Preferably, the LP40 electrolyte contact angle measurement will be less than 10° after 1 minute.

The battery separator may be used in any number of different types of batteries. One common type of battery for which the battery separator may be used is a lithium-ion battery. In addition to the battery separator, the lithium-ion battery may also include a positive electrode (also known as a cathode), a negative electrode (also known as an anode), and an electrolyte. The electrolyte will comprise a lithium salt such as lithium hexafluorophosphate, lithium hexafluoroarsenate monohydrate, lithium perchlorate, lithium tetrafluoroborate, lithium triflate, or the like, and an organic solvent such as an ethylene carbonate, a diethyl carbonate, and the like.

The lithium-ion battery may come in many configurations. One such configuration is a cylindrical shape lithium-ion battery in which the battery separator is sandwiched between the positive electrode (cathode) and the negative electrode (anode) and rolled into a single spool. Another configuration is a stacked configuration in which the battery separator is sandwiched between a substantially flat sheet positive electrode (cathode) and a substantially flat sheet negative electrode (anode).

The battery separator may be prepared using the following process. First, an amount of cellulosic fibers are provided. The cellulosic fibers may be of any type disclosed herein including hardwood fibers, softwood fibers, Lyocell fibers, and combinations thereof. In some embodiments, this step may also include providing an amount of aramid fibers.

Next, the cellulosic fibers may be subjected to a refining step to obtain highly refined cellulosic fibers. The refining step may include imparting energy (i.e.,—shear, fibrillation) to the fibers in order to reduce their length and thickness. When present, the refining step may also be conducted upon the aramid fibers. Upon completion of the refining step, the highly refined cellulosic fibers (and optional aramid fibers) will have a refining degree which may be measured using a Schopper-Reigler (SR) freeness tester. The preferred refining degree may be at least 60° with at least 65° being more preferred and at least 70° being most preferred. The amount of refining may also be measured based on the weight % of secondary fines in the highly refined cellulosic fibers. Preferably, the highly refined cellulosic fibers will include greater than 35 wt. % secondary fines based on total weight of the highly refined cellulosic fibers, more preferably greater than 40 wt. % secondary fines based on total weight of the highly refined cellulosic fiber, and most preferably greater than 45 wt. % secondary fines based on total weight of the highly refined cellulosic fiber.

Upon completion of the refining step, an amount of synthetic fibers may be added to the highly refined cellulosic fibers (and optional aramid fibers) to obtain a first fiber mixture. The first fiber mixture may be said to comprise the synthetic fibers and the highly refined cellulosic fibers (and the optional aramid fibers). The synthetic fibers may be of any type disclosed herein including polyester fibers, polyolefin fibers, polyaramid fibers, and combinations thereof.

Once the synthetic fibers are added, an amount of a first solvent may be added to the first fiber mixture to obtain a first fibrous slurry. In preferred embodiments, the solvent is water.

The first fibrous slurry may then be transferred to a headbox to be deposited to a forming wire or forming fabric. Once deposited to the forming fabric or forming wire, a vacuum condition may be applied to the first fibrous slurry to remove at least a portion of the first solvent. Removing a portion of the first solvent will result in formation of the non-woven substrate.

Once the non-woven substrate is formed, a binder may be applied to at least a first surface of the non-woven substrate to obtain the battery separator. The binder may be of any type disclosed herein including polymer binders such as styrene-butadiene polymers, polyolefins, polyvinylidene fluoride (PVDF), and polytetrafluoroethylene (PTFE).

In some embodiments, the process may further comprise a calendaring step. The calendaring step may be conducted prior to, concurrent with, and/or after applying the binder to the non-woven substrate.

The battery separators disclosed herein have been observed to have improved flexibility which allows for better handling during the battery fabrication process. Additionally, the battery separators disclosed herein have also been observed to have good wettability with improved affinity for organic solvents. Also, the battery separators disclosed herein with their small pore sizes have been observed to have high ionic resistivity and enhances the formation of dendrites which in turn reduces the risk of current shortcuts and exposure.

### Examples

The following test methods were employed to obtain the data reported in the tables below.
Basis Weight: The basis weight is measured according to TAPPI Standard T410 and reported in grams per square meter (gr/m²) or pounds per 3,000 square feet (lb/3000 ft²).
Thickness at 100 kilopascals (Kpa): The thickness at 100 Kpa is measured according to ISO Standard 534:1988 and reported in micrometers (μm).
Air Permeability: The air permeability was measured according to DIN Standard 53,887.
Bendtsen Roughness: The Bendtsen roughness was measured according to ISO Standard 5636-1: 1984.
Gurley Permeability: The Gurley permeability was measured according to ISO Standard 5636:1.
Tensile Machine Direction (MD): The tensile strength in the machine direction (MD) was measured according to TAPPI Standard T494 and reported in Newtons per meter (N/m).
Elongation Machine Direction (MD): The elongation strength in the machine direction (MD) was measured according to TAPPI Standard T494 and reported as a percentage (%).
Tensile Cross Direction (CD): The tensile strength in the cross direction (CD) was measured according to TAPPI Standard T494 and reported in Newtons per meter (N/m).
Elongation Cross Direction (CD): The elongation strength in the cross direction (CD) was measured according to TAPPI Standard T494 and reported as a percentage (%).

The following materials were employed in the battery separator examples reported in the tables below.
HRCF1: Lyocell L 104 highly fibrillated fiber having a Canadian Standard Freeness (CSF) of 10 available from Engineered Fibers Technology, LLC of Longmeadow, Massachusetts, U.S.A.
SE: polyethylene terephthalate fiber having a linear density of 0.06 dtex and a 3 mm fiber length available Teijin Limited of Tokyo, Japan.
AF1: Kevlar® 1F361 aramid fibers available from DuPont de Nemours, Inc. of Wilmington, Delaware, U.S.A.
MFC1: Integrand Strong micro fibrillated cellulosic fibers available from Stora Enso Oyj of Helsinki, Finland.
B1: Kynar Flex® polyvinylidene fluoride (PVDF) resin LBG 2200 LX available from Arkema Inc. of King of Prussia, Pennsylvania, U.S.A.
B2: Solef® polyvinylidene fluoride (PVDF) copolymer XPH 883 available from Solvay S.A. of Brussels, Belgium.
B3: Acronal® LN 838 S water-based acrylic and styrene-acrylic emulsion polymer available from BASF SE.
B4: CelluForce NCC® EC50 binder comprising sulphated cellulose nanoparticulate polyols available from CelluForce Inc of Montreal, Canada.

The following battery separators were prepared and tested for various properties with the test results reported in the tables below.
Comparative Example 1 (CE1): Comparative example 1 (sometimes referred to herein as “CE1”) was made on a wet-laid machine using an inclined forming wire. CE1 did not include any binder. The fibers of CE1 comprised a mixture of highly refined cellulosic fibers, synthetic fibers, aramid fibers, and micro fibrillated cellulosic fibers with 35 wt. % of CE1 being HRCF1 fibers, 35 wt. % of CE1 being AF1 fibers, 20 wt. % of CE1 being SF1 fibers, and 10 wt. % of CE1 being MFC1 fibers.
Comparative Example 2 (CE2): Comparative example 2 (sometimes referred to herein as “CE2”) was made on a wet-laid machine using an inclined forming wire. CE2 did not include any binder. The fibers of CE2 comprised a mixture of highly refined cellulosic fibers, synthetic fibers and micro fibrillated cellulosic fibers with 38 wt. % of CE2 being HRCF1 fibers, 22 wt. % of AF1 fibers, 20 wt. % of CE2 being SF1 fibers, and 20 wt. % of CE2 being MFC1 fibers.
Comparative Example 3 (CE3): Comparative example 3 (sometimes referred to herein as “CE3”) was made on a wet-laid machine using an inclined forming wire. CE3 did not include any binder. The fibers of CE3 comprised a mixture of highly refined cellulosic fibers, synthetic fibers and micro fibrillated cellulosic fibers with 60 wt. % of CE3 being HRCF1 fibers, 20 wt. % of CE3 being SF1 fibers, and 20 wt. % of CE3 being MFC1 fibers.
Comparative Example 4 (CE4): Comparative example 4 (sometimes referred to herein as “CE4”) was made on a wet-laid machine using an inclined forming wire. CE4 did not include any binder. The fibers of CE4 comprised a mixture of highly refined cellulosic fibers, synthetic fibers and micro fibrillated cellulosic fibers with 50 wt. % of CE4 being HRCF1 fibers, 30 wt. % of CE4 being SF1 fibers, and 20 wt. % of CE4 being MFC1 fibers.
Comparative Example 5 (CE5): Comparative example 5 (sometimes referred to herein as “CE5”) was made on a wet-laid machine using an inclined forming wire. CE5 did not include any binder. The fibers of CE5 comprised a mixture of highly refined cellulosic fibers, synthetic fibers, aramid fibers, and micro fibrillated cellulosic fibers with 35 wt. % of CE5 being HRCF1 fibers, 35 wt. % of CE5 being AF1 fibers, 20 wt. % of CE5 being SF1 fibers, and 10 wt. % of CE5 being MFC1 fibers. The resulting structure was then subjected to a calendering step at a temperature of 80° C., and a pressure of 3250 dekanewtons per centimeter (daN/cm).
Comparative Example 6 (CE6): Comparative example 6 (sometimes referred to herein as “CE6”) was made on a wet-laid machine using an inclined forming wire. The fibers of CE6 comprised a mixture of highly refined cellulosic fibers, synthetic fibers, aramid fibers, and micro fibrillated cellulosic fibers with 35 wt. % of CE6 being HRCF1 fibers, 35 wt. % of CE6 being AF1 fibers, 20 wt. % of CE6 being SF1 fibers, and 10 wt. % of CE6 being MFC1 fibers. CE6 contained an identical composition of fibers as CE1 and CE5 but was made on a different wet-laid machine.
Comparative Example 7 (CE7): Comparative example 7 (sometimes referred to herein as “CE7”) was made on a wet-laid machine using an inclined forming wire. The fibers of CE7 comprised a mixture of highly refined cellulosic fibers, synthetic fibers, aramid fibers, and micro fibrillated cellulosic fibers with 35 wt. % of CE7 being HRCF1 fibers, 35 wt. % of CE7 being AF1 fibers, 20 wt. % of CE7 being SF1 fibers, and 10 wt. % of CE7 being MFC1 fibers. CE7 contained an identical composition of fibers as CE1 and CE5 but was made on a different wet-laid machine. The resulting structure was then subjected to a calendering step at a temperature of 80° C., and a pressure of 3250 daN/cm.
Working Example 1 (WE1): Working example 1 (sometimes referred to herein as “WE1”) was made on a wet-laid machine using an inclined wire forming wire. WE1 comprised a mixture of highly refined cellulosic fibers, synthetic fibers, aramid fibers, and micro fibrillated cellulosic fibers with 35 wt. % of the total fibers in WE1 being HRCF1 fibers, 35 wt. % of the total fibers in WE1 being AF1 fibers, 20 wt. % of the total fibers in WE1 being SF1 fibers, and 10 wt. % of the total fibers in WE1 being MFC1 fibers. After forming the fiber layer on the wet-laid machine, 4 g/m² of binder B2 were applied to a single surface as an additional layer.
Working Example 2 (WE2): Working example 2 (sometimes referred to herein as “WE2”) was made on a wet-laid machine using an inclined forming wire. WE2 comprised a mixture of highly refined cellulosic fibers, synthetic fibers, aramid fibers, and micro fibrillated cellulosic fibers with 35 wt. % of the total fibers in WE2 being HRCF1 fibers, 35 wt. % of the total fibers in WE2 being AF1 fibers, 20 wt. % of the total fibers in WE2 being SF1 fibers, and 10 wt. % of the total fibers in WE2 being MFC1 fibers. After forming the fiber layer on the wet-laid machine, 2 g/m² of binder B2 were applied to both opposing surfaces of the fiber layer as additional layers using a spray coating process.
Working Example 3 (WE3): Working example 3 (sometimes referred to herein as “WE3”) was made on a wet-laid machine using an inclined forming wire. The fibers of WE3 comprised a mixture of highly refined cellulosic fibers, synthetic fibers and micro fibrillated cellulosic fibers with 38 wt. % of the total fibers of WE3 being HRCF1 fibers, 22 wt. % of the total fibers of WE3 being AF1 fibers, 20 wt. % of the total fibers of WE3 being SF1 fibers, and 20 wt. % of the total fibers of WE3 being MFC1 fibers. During formation, the fiber layer was coated with 4 g/m² of B1 binder.
Working Example 4 (WE4): Working example 4 (sometimes referred to herein as “WE4”) was made on a wet-laid machine using an inclined forming wire. The fibers of WE4 comprised a mixture of highly refined cellulosic fibers, synthetic fibers and micro fibrillated cellulosic fibers with 38 wt. % of the total fibers of WE4 being HRCF1 fibers, 22 wt. % of the total fibers of WE4 being AF1 fibers, 20 wt. % of the total fibers of WE4 being SF1 fibers, and 20 wt. % of the total fibers of WE4 being MFC1 fibers. During formation, the fiber layer was coated with 4 g/m² of B2 binder.
Working Example 5 (WE5): Working example 5 (sometimes referred to herein as “WE5”) was made on a wet-laid machine using an inclined forming wire. The fibers of WE5 comprised a mixture of highly refined cellulosic fibers, synthetic fibers and micro fibrillated cellulosic fibers with 60 wt. % of the total fibers of WE5 being HRCF1 fibers, 20 wt. % of the total fibers of WE5 being SF1 fibers, and 20 wt. % of the total fibers of WE5 being MFC1 fibers. During formation, the fiber layer was coated with 4 g/m² of B1 binder.
Working Example 6 (WE6): Working example 6 (sometimes referred to herein as “WE6”) was made on a wet-laid machine using an inclined forming wire. The fibers of WE6 comprised a mixture of highly refined cellulosic fibers, synthetic fibers and micro fibrillated cellulosic fibers with 60 wt. % of the total fibers of WE6 being HRCF1 fibers, 20 wt. % of the total fibers of WE6 being SF1 fibers, and 20 wt. % of the total fibers of WE6 being MFC1 fibers. During formation, the fiber layer was coated with 4 g/m² of B2 binder.
Working Example 7 (WE7): Working example 7 (sometimes referred to herein as “WE7”) was made on a wet-laid machine using an inclined forming wire. The fibers of WE7 comprised a mixture of highly refined cellulosic fibers, synthetic fibers and micro fibrillated cellulosic fibers with 50 wt. % of the total fibers of WE7 being HRCF1 fibers, 30 wt. % of the total fibers of WE7 being SF1 fibers, and 20 wt. % of the total fibers of WE7 being MFC1 fibers. During formation, the fiber layer was coated with 4 g/m² of B1 binder.
Working Example 8 (WE8): Working example 8 (sometimes referred to herein as “WE8”) was made on a wet-laid machine using an inclined forming wire. The fibers of WE8 comprised a mixture of highly refined cellulosic fibers, synthetic fibers and micro fibrillated cellulosic fibers with 50 wt. % of the total fibers of WE8 being HRCF1 fibers, 30 wt. % of the total fibers of WE8 being SF1 fibers, and 20 wt. % of the total fibers of WE8 being MFC1 fibers. During formation, the fiber layer was coated with 4 g/m² of B2 binder.
Working Example 9 (WE9): Working example 9 (sometimes referred to herein as “WE9”) was made on a wet-laid machine using an inclined forming wire. The fibers of WE9 comprised a mixture of highly refined cellulosic fibers, synthetic fibers, aramid fibers, and micro fibrillated cellulosic fibers with 35 wt. % of the total fibers of WE9 being HRCF1 fibers, 35 wt. % of the total fibers of WE9 being AF1 fibers, 20 wt. % of the total fibers of WE9 being SF1 fibers, and 10 wt. % of the total fibers of WE9 being MFC1 fibers. After forming the fiber layer on the wet-laid machine, 4 g/m² of binder B4 were applied to a single surface as an additional layer using a direct roll process.
Working Example 10 (WE10): Working example 10 (sometimes referred to herein as “WE10”) was made on a wet-laid machine using an inclined forming wire. The fibers of WE10 comprised a mixture of highly refined cellulosic fibers, synthetic fibers, aramid fibers, and micro fibrillated cellulosic fibers with 35 wt. % of the total fibers of WE10 being HRCF1 fibers, 35 wt. % of the total fibers of WE10 being AF1 fibers, 20 wt. % of the total fibers of WE10 being SF1 fibers, and 10 wt. % of the total fibers of WE10 being MFC1 fibers. After forming the fiber layer on the wet-laid machine, 4 g/m² of binder B1 were applied to a single surface as an additional layer using a size press process.
Working Example 11 (WE11): Working example 11 (sometimes referred to herein as “WE11”) was made on a wet-laid machine using an inclined forming wire. WE11 comprised a mixture of highly refined cellulosic fibers, synthetic fibers, aramid fibers, and micro fibrillated cellulosic fibers with 35 wt. % of the total fibers in WE11 being HRCF1 fibers, 35 wt. % of the total fibers in WE11 being AF1 fibers, 20 wt. % of the total fibers in WE11 being SF1 fibers, and 10 wt. % of the total fibers in WE11 being MFC1 fibers. After forming the fiber layer on the wet-laid machine, 2 g/m² of binder B2 were applied to both opposing surfaces of the fiber layer as additional layers using a spray coating process. The resulting structure was then subjected to a calendering step at a temperature of 80° C., and a pressure of 3250 daN/cm.
Working Example 12 (WE12): Working example 12 (sometimes referred to herein as “WE12”) was made on a wet-laid machine using an inclined forming wire. The fibers of WE12 comprised a mixture of highly refined cellulosic fibers, synthetic fibers, aramid fibers, and micro fibrillated cellulosic fibers with 35 wt. % of the total fibers of WE12 being HRCF1 fibers, 35 wt. % of the total fibers of WE12 being AF1 fibers, 20 wt. % of the total fibers of WE12 being SF1 fibers, and 10 wt. % of the total fibers of WE12 being MFC1 fibers. After forming the fiber layer on the wet-laid machine, 4 g/m² of binder B4 were applied to a single surface as an additional layer using a direct roll process. The resulting structure was then subjected to a calendering step at a temperature of 100° C., and a pressure of 370 kilonewtons per meter (KN/m).
Working Example 13 (WE13): Working example 13 (sometimes referred to herein as “WE13”) was made on a wet-laid machine using an inclined forming wire. The fibers of WE13 comprised a mixture of highly refined cellulosic fibers, synthetic fibers, aramid fibers, and micro fibrillated cellulosic fibers with 35 wt. % of the total fibers of WE13 being HRCF1 fibers, 35 wt. % of the total fibers of WE13 being AF1 fibers, 20 wt. % of the total fibers of WE13 being SF1 fibers, and 10 wt. % of the total fibers of WE13 being MFC1 fibers. After forming the fiber layer on the wet-laid machine, 4 g/m² of binder B1 were applied to a single surface as an additional layer using a size press process. The resulting structure was then subjected to a calendering step at a temperature of 100° C., and a pressure of 350 KN/m.
Working Example 14 (WE14): Working example 14 (sometimes referred to herein as “WE14”) was made on a wet-laid machine using an inclined wire forming wire. The fibers of WE14 comprised a mixture of highly refined cellulosic fibers, synthetic fibers, aramid fibers, and micro fibrillated cellulosic fibers with 35 wt. % of the total fibers of WE14 being HRCF1 fibers, 35 wt. % of the total fibers of WE14 being AF1 fibers, 20 wt. % of the total fibers of WE14 being SF1 fibers, and 10 wt. % of the total fibers of WE14 being MFC1 fibers. After forming the fiber layer on the wet-laid machine, 4 g/m² of binder B5 were applied to a single surface as an additional layer using a size press process. The resulting structure was then subjected to a calendering step at a temperature of 80° C., and a pressure of 3250 daN/cm.
Working Example 15 (WE15): Working example 15 (sometimes referred to herein as “WE15”) was made on a wet-laid machine using an inclined forming wire. The fibers of WE15 comprised a mixture of highly refined cellulosic fibers, synthetic fibers, aramid fibers, and micro fibrillated cellulosic fibers with 35 wt. % of the total fibers in WE15 being HRCF1 fibers, 35 wt. % of the total fibers in WE15 being AF1 fibers, 20 wt. % of the total fibers in WE15 being SF1 fibers, and 10 wt. % of the total fibers in WE15 being MFC1 fibers. After forming the fiber layer on the wet-laid machine, approximately 5 g/m2 of binder B3 was applied to a single surface as an additional layer using a size press process.
Working Example 16 (WE16): Working example 16 (sometimes referred to herein as “WE16”) was made on a wet-laid machine using an inclined forming wire. The fibers of WE16 comprised a mixture of highly refined cellulosic fibers, synthetic fibers, aramid fibers, and micro fibrillated cellulosic fibers with 35 wt. % of the total fibers in WE16 being HRCF1 fibers, 35 wt. % of the total fibers in WE16 being AF1 fibers, 20 wt. % of the total fibers in WE16 being SF1 fibers, and 10 wt. % of the total fibers in WE16 being MFC1 fibers. After forming the fiber layer on the wet-laid machine, approximately 5 g/m2 of binder B3 was applied to a single surface as an additional layer using a size press process. The resulting structure was then subjected to a calendering step at a temperature of 80° C., and a pressure of 3250 daN/cm.
Working Example 17 (WE17): Working example 17 (sometimes referred to herein as “WE17”) was made on a wet-laid machine using an inclined forming wire. The fibers of WE17 comprised a mixture of highly refined cellulosic fibers, synthetic fibers, aramid fibers, and micro fibrillated cellulosic fibers with 35 wt. % of the total fibers in WE17 being HRCF1 fibers, 35 wt. % of the total fibers in WE17 being AF1 fibers, 20 wt. % of the total fibers in WE17 being SF1 fibers, and 10 wt. % of the total fibers in WE17 being MFC1 fibers. After forming the fiber layer on the wet-laid machine, approximately 5 g/m2 of binder B3 was applied to a single surface as an additional layer using a size press process. The resulting structure was then subjected to a calendering step at a temperature of 100° C., and a pressure of 300 kN/m.
Working Example 18 (WE18): Working example 18 (sometimes referred to herein as “WE18”)) was made on a wet-laid machine using an inclined forming wire. The fibers of WE18 comprised a mixture of highly refined cellulosic fibers, synthetic fibers, aramid fibers, and micro fibrillated cellulosic fibers with 35 wt. % of WE18 being HRCF1 fibers, 35 wt. % of WE18 being AF1 fibers, 20 wt. % of WE18 being SF1 fibers, and 10 wt. % of WE18 being MFC1 fibers. WE18 contained an identical composition of fibers as CE1 and CE5 but was made on a different wet-laid machine. After forming the fiber layer on the wet-laid machine, 3.6 g/m2 of binder B4 was applied to a single surface using a spray coating process. The resulting structure was then subjected to a calendering step at a temperature of 80° C., and a pressure of 3250 daN/cm.
Working Example 19 (WE19): Working example 19 (sometimes referred to herein as “WE19”)) was made on a wet-laid machine using an inclined forming wire. The fibers of WE19 comprised a mixture of highly refined cellulosic fibers, synthetic fibers, aramid fibers, and micro fibrillated cellulosic fibers with 35 wt. % of WE19 being HRCF1 fibers, 35 wt. % of WE19 being AF1 fibers, 20 wt. % of WE19 being SF1 fibers, and 10 wt. % of WE19 being MFC1 fibers. WE19 contained an identical composition of fibers as CE1 and CE5 but was made on a different wet-laid machine. After forming the fiber layer on the wet-laid machine, 3 g/m2 of binder B4 was applied to a single surface using a spray coating process. The resulting structure was then subjected to a calendering step at a temperature of 80° C., and a pressure of 3250 daN/cm.
Working Example 20 (WE20): Working example 20 (sometimes referred to herein as “WE20”)) was made on a wet-laid machine using an inclined forming wire. The fibers of WE20 comprised a mixture of highly refined cellulosic fibers, synthetic fibers, aramid fibers, and micro fibrillated cellulosic fibers with 35 wt. % of WE20 being HRCF1 fibers, 35 wt. % of WE20 being AF1 fibers, 20 wt. % of WE20 being SF1 fibers, and 10 wt. % of WE20 being MFC1 fibers. WE20 contained an identical composition of fibers as CE1 and CE5 but was made on a different wet-laid machine. After forming the fiber layer on the wet-laid machine, 2.1 g/m2 of binder B4 was applied to a single surface using a spray coating process. The resulting structure was then subjected to a calendering step at a temperature of 80° C., and a pressure of 3250 daN/cm.

The comparative and working examples were then tested for various properties including basis weight, thickness, air permeability, roughness, shrinkage, tensile strength, and elongation. The results of these tests are summarized in the tables below.

TABLE I
Effect of Binder on Air Permeability, Tensile Strength, Elongation, and Shrinkage

| | | | Air | Dry | | Wet | | | | |
|---|---|---|---|---|---|---|---|---|---|---|
| | | Thickness— | Permeability | Tensile | Dry | Tensile | Wet | Shrinkage | Shrinkage | Shrinkage |
| | Grammage | 100 kPa | Bendsten | Strength | Elongation | Strength | Elongation | (%) at | (%) at | (%) at |
| Example | (g/m²) | (μm) | (l/min) | (N/m) | (%) | (N/m) | (%) | 160° C. | 200° C. | 230° C. |
| CE2 | 18 | 60 | 2.49 | 450 | 3.9 | 60 | 15.2 | | | |
| CE3 | 17 | 58 | 1.80 | 620 | 4.0 | 50 | 19.3 | 0.67 | 0.81 | 0.94 |
| CE4 | 18 | 58 | 2.29 | 650 | 5.4 | 50 | 11.1 | 0.67 | 0.61 | 0.72 |
| WE3 | 18 | 56 | 0.38 | 410 | 4.7 | 100 | 10.9 | | | |
| WE4 | 18 | 57 | 0.64 | 740 | 7.0 | 300 | 17.9 | 0.56 | 0.89 | 1.00 |
| WE5 | 18 | 56 | 0.31 | 400 | 5.5 | 90 | 15.0 | 0.50 | 0.75 | 1.13 |
| WE6 | 18 | 56 | 0.43 | 790 | 7.3 | 320 | 17.4 | | | |
| WE7 | 18 | 58 | 0.38 | 450 | 6.9 | 150 | 10.1 | 0.67 | 0.83 | 1.06 |
| WE8 | 18 | 54 | 0.60 | 660 | 7.5 | 250 | 18.3 | 0.64 | 0.86 | 1.08 |

As seen in Table I above, the binder—which was present in each of the working examples, but not present in any of the comparative examples—significantly reduced the air permeability of the resulting battery separator. The working examples with binder also demonstrated improvements in tensile strength (wet and/or dry) and elongation (wet and or dry).

TABLE II
Effect of Binder on Air Permeability, Tensile Strength, Elongation, Shrinkage, and Porosity

| | | | Air | | Air | Dry | | Dry | | Wet | Wet | Wet | |
|---|---|---|---|---|---|---|---|---|---|---|---|---|---|
| | | Thick- | Perme- | | Perme- | Tensile | Dry | Tensile | Dry | Tensile | Elon- | Tensile | Wet |
| | Gram- | ness— | ability | | ability | Strength— | Elon- | Strength— | Elon- | Strength— | gation— | Strength— | Elon- |
| | mage | 100 kPa | Bendsten | % | (Textest) | MD | gation— | CD | gation— | MD | | CD | gation— |
| Example | (g/m²) | (μm) | (l/min) | Pores | (l/m2/s) | (N/m) | MD (%) | (N/m) | CD (%) | (N/m) | MD (%) | (N/m) | CD (%) |
| CE1 | 16 | 47 | 9.20 | 76.00 | 25.71 | 605 | 3 | 140 | 5 | 88 | 4 | 27 | 18 |
| WE1 | 20 | 50 | 5.22 | 72.00 | 16.90 | 940 | 3 | 285 | 9 | 468 | 8 | 110 | 19 |
| WE2 | 20 | 49 | 6.26 | 71.00 | 7619.06 | 918 | 4 | 240 | 7 | 418 | 8 | 83 | 18 |

Table II above further demonstrates the improved air permeability, tensile strength (wet and/or dry) and elongation (wet and or dry) of the battery separator resulting from use of a binder.

TABLE III
Effect of Binder on Pinholes, Air Permeability and Roughness

| | | No. of | No. of | No. of | No. of | No. of | | | |
|---|---|---|---|---|---|---|---|---|---|
| | No. of | Pinholes | Pinholes | Pinholes | Pinholes | Pinholes | Air | | |
| | Total | (10- | (25- | (50- | (75- | (100- | Permeability | Gurley | |
| | Pinholes | 25 μm) | 50 μm) | 75 μm) | 100 μm) | 150 μm) | Bendsten | Roughness | |
| Example | per m² | per m² | per m² | per m² | per m² | per m² | (l/min) | (s) | Threshold |
| CE1 | 49,050 | 25,000 | 17,530 | 5,000 | 1,130 | 390 | 9.2 | 1.2 | 180-255 |
| WE2 | 20,952 | 11,052 | 7,452 | 1,842 | 457 | 147 | 5.2 | 1.8 | 180-255 |
| WE9 | 20,468 | 10,703 | 7,390 | 2,031 | 249 | 93 | 4.7 | 2.2 | 190-255 |
| WE10 | 26,331 | 13,347 | 10,121 | 2,236 | 521 | 105 | 3.5 | 2.6 | 180-255 |

As seen in Table III above, the presence of the binder significantly reduces the amount of pinholes across a wide array of hole sizes while also improving smoothness and reducing air permeability of the resulting battery separator.

TABLE IV
Effect of Binder on Pinholes

| | No. of | No. of | No. of | No. of | No. of | No. of | |
|---|---|---|---|---|---|---|---|
| | Total | Pinholes | Pinholes | Pinholes | Pinholes | Pinholes | |
| | Pinholes | (10-25 μm) | (25-50 μm) | (50-75 μm) | (75-100 μm) | (100-150 μm) | |
| Example | per m² | per m² | per m² | per m² | per m² | per m² | Threshold |
| CE1 | 49,050 | 25,000 | 17,530 | 5,000 | 1,130 | 390 | 180-255 |
| WE2 | 20,952 | 11,052 | 7,452 | 1,842 | 457 | 147 | 180-255 |
| WE9 | 20,468 | 10,703 | 7,390 | 2,031 | 249 | 93 | 190-255 |
| WE10 | 26,331 | 13,347 | 10,121 | 2,236 | 521 | 105 | 180-255 |
| CE5 | 18,987 | 9,662 | 7,100 | 1,887 | 237 | 100 | 190-255 |
| WE11 | 5,670 | 3,140 | 2,025 | 405 | 85 | 15 | 190-255 |
| WE12 | 5,116 | 2,858 | 1,857 | 367 | 33 | 0 | 195-255 |
| WE13 | 5,857 | 3,073 | 2,115 | 500 | 152 | 15 | 190-255 |
| WE14 | 6,800 | 3,625 | 2,316 | 583 | 216 | 41 | 190-255 |
| WE15 | 12310 | 6480 | 4390 | 1160 | 210 | 70 | 190-255 |
| WE16 | 4200 | 2340 | 1560 | 290 | 10 | 0 | 200-255 |
| WE17 | 1925 | 1110 | 715 | 80 | 10 | 10 | 200-255 |

The total number of pinholes reported in Table IV above is based on measurement of 20 zones in the example with each zone being a square having dimensions of 10 cm×10 cm. The number of pinholes within each zone was calculated and converted to a number of pinholes per square meter. The number of total pinholes per m² reported in Table IV is an average of the 20 zones measured.

The threshold measurement reported in Table IV is a measurement of black/white used to determine the location of pinholes within the battery separator on a scale of 0-255 with 0 referring to black and the threshold range reported in Table IV referring to the range at which white is detected such that pinholes may be detected. The pinholes are measured using the Pinholes Module in a DOMAS Multispec Imaging system. The Pinholes module is an advanced modular image analysis system which provides a tool for automatically detecting pinholes. The module uses a flat bed scanner for objective detection of pinholes and translucent areas in the paper. Starting from a scan in transmitted light with a resolution of 1500 dots per inch (dpi), the pinholes are detected from a size of approximately 10 μm. The detected pinholes will be visualized with an overlay after measurement. Pinholes are point-shaped translucent spots in the paper that impair its quality and may cause some issue when used as a battery separator (current short cut, decrease of the life time of the batter, impact on performance, etc.).

As seen in Table IV above, calendering the battery separator achieves further improvements in pinhole amount and size. It is notable that the combined effect of calendering and synthetic resin as shown across examples CE1, CE5, WE2, and WE1l demonstrates improvements in pinhole amount and size when compared to the effects achieved individually by calendering and synthetic resin.

Additional comparative and comparative examples were prepared, where the working examples comprise a nonwoven substrate and various coating amounts of a binder comprising cellulose. As seen in Table V and Table VI below, the working examples demonstrated improvements in tensile strength and elongation. The presence of the cellulose binder significantly reduced the amount of pinholes across a wide array of hole sizes.

TABLE V
Effect of Cellulose Binder on Air Permeability, Tensile Strength, Elongation, and Porosity

| | | | | Air | | | | | |
|---|---|---|---|---|---|---|---|---|---|
| | | Coating | Thickness— | Permeability | | Dry Tensile | Dry | Dry Tensile | Dry |
| | Grammage | Amount | 100 kPa | Bendsten | % | Strength— | Elongation— | Strength— | Elongation— |
| Example | (g/m²) | (g/m²) | (μm) | (1/min) | Pores | MD (N/m) | MD (%) | CD (N/m) | CD (%) |
| CE6 | 15 | — | 45 | 4.14 | 76.1 | 479 | 3.2 | 235 | 5.2 |
| CE7 | 15 | — | 21 | 0.90 | 48.9 | 475 | 3.0 | 270 | 4.0 |
| WE18 | 19 | 3.6 | 23 | 0.02 | 41.6 | 1160 | 4.2 | 595 | 6.1 |
| WE19 | 19 | 3.0 | 23 | 0.03 | 44.1 | 1125 | 4.0 | 558 | 5.5 |
| WE20 | 18 | 2.1 | 23 | 0.15 | 46.8 | 885 | 3.3 | 460 | 5.7 |

TABLE VI
Effect of Cellulose Binder on Pinholes

| | No. of | No. of | No. of | No. of | No. of | No. of | |
|---|---|---|---|---|---|---|---|
| | Total | Pinholes | Pinholes | Pinholes | Pinholes | Pinholes | |
| | Pinholes | (10-25 μm) | (25-50 μm) | (50-75 μm) | (75-100 μm) | (100-150 μm) | |
| Example | per m² | per m² | per m² | per m² | per m² | per m² | Threshold |
| CE6 | 19,400 | 5,229 | 12,200 | 1,020 | 70 | 20 | 140-255 |
| CE7 | 4,890 | 3,420 | 1,270 | 160 | 40 | 0 | 160-255 |
| WE18 | 730 | 460 | 270 | 0 | 0 | 0 | 160-255 |
| WE19 | 550 | 400 | 120 | 30 | 0 | 0 | 160-255 |
| WE20 | 487 | 297 | 162 | 10 | 19 | 0 | 160-255 |

1. A battery separator comprising:
a non-woven substrate comprising highly refined cellulosic fibers and synthetic fibers; and
a binder;
wherein the battery separator has a mean pore size in a range of between 0.4 and 3 μm, and
wherein the highly refined cellulosic fibers are composed of or derived from cellulose having at least 60 wt. % fines based on total weight of the cellulosic fibers and at least 35 wt. % secondary fines based on total weight the fines.

2. The battery separator of claim 1,
wherein the highly refined cellulosic fibers are selected from the group consisting of hardwood fibers, softwood fibers, regenerated cellulose fibers such as Lyocell fibers, and combinations thereof, and
optionally wherein the softwood fibers are bleached softwood fibers.

3. (canceled)

4. The battery separator of claim 1, wherein the synthetic fibers are selected from the group consisting of polyester fibers, polyolefin fibers, polyaramid fibers, and combinations thereof.

5. The battery separator of claim 1, wherein
the synthetic fibers have a synthetic fiber diameter of less than 10 μm,
the synthetic fibers have a synthetic fiber length of no greater than 12 mm, or both.

6. (canceled)

7. The battery separator of claim 1, wherein the synthetic fibers are present in the non-woven substrate at a level of at least 20 wt. % based on total weight of the fibers in the non-woven substrate.

8. The battery separator of claim 1, further comprising micro fibrillated cellulosic fibers,
optionally wherein the micro fibrillated cellulosic fibers are present in the non-woven substrate in a range of between 10 and 30 wt. % based on total weight of the fibers in the non-woven substrate.

9. (canceled)

10. The battery separator of claim 1, further comprising aramid fibers,
optionally wherein the aramid fibers are para-aramid fibers.

11. (canceled)

12. The battery separator of claim 1, wherein the binder is a polymer binder.

13. The battery separator of claim 12, wherein the polymer binder has a melting point greater than 80° C.

14. The battery separator of claim 12, wherein the polymer binder comprises
a polymer selected from the group consisting of styrene-butadiene polymers, polyolefins, polyvinylidene fluoride (PVDF), polytetrafluoroethylene (PTFE), and acrylics, cellulose polymers, cellulose-containing polymers or cellulose-derived polymers, or combinations thereof.

15. (canceled)

16. The battery separator of claim 1, wherein the non-woven substrate is coated with the binder.

17. The battery separator of claim 1,
wherein the binder is a binder layer formed on at least one surface of the non-woven substrate, and
optionally wherein the binder of the binder layer penetrates a depth of the non-woven substrate in the z-direction.

18. (canceled)

19. The battery separator of claim 1, wherein a first porosity is less than 2 L/min.

20. The battery separator of claim 1, having an LP40 electrolyte contact angle measurement of less than 10° after 1 minute.

21. A lithium-ion battery comprising the battery separator of claim 1.

22. A process for producing a battery separator, the process comprising:
providing an amount of cellulosic fibers;
subjecting the cellulosic fibers to a refining step to obtain highly refined cellulosic fibers having a refining degree of at least 60° when measured using a Schopper-Reigler (SR) freeness tester;
adding an amount of synthetic fibers to the highly refined cellulosic fibers to obtain a first fiber mixture;
adding an amount of a first solvent to the first fiber mixture to obtain a first fibrous slurry, wherein the first solvent comprises water;
transferring the first fibrous slurry to a headbox;
depositing the first fibrous slurry to a forming wire or a forming fabric;
applying a vacuum condition to the first fibrous slurry to remove at least a portion of the first solvent and form a non-woven substrate; and
applying a binder to at least a first surface of the non-woven substrate to produce the battery separator.

23. The process for producing a battery separator of claim 22, wherein
the providing the amount of cellulosic fibers further comprises providing an amount of aramid fibers, and
the subjecting the cellulosic fibers to the refining step further comprises subjecting the aramid fibers to the refining step.

24. The process for producing a battery separator of claim 22, further comprising
subjecting the produced battery separator to calendaring.

25. A battery separator comprising a sheet-like porous structure, the sheet-like porous structure comprising:
a non-woven substrate comprising highly refined cellulosic fibers and synthetic fibers; and
a binder,
wherein the sheet-like porous structure has a mean pore size in a range of between 0.4 and 3 μm,
wherein the highly refined cellulosic fibers are composed of or derived from cellulose having at least 60 wt. % fines based on total weight of the cellulosic fibers and at least 35 wt. % secondary fines based on total weight the fines.

26. A lithium-ion battery comprising the battery separator of claim 15.
